(19) United States
(12) Patent Application Publication
(10) Pub. No.: US 2025/0018475 A1
(43) Pub. Date: Jan. 16, 2025

(54) METHOD AND MACHINE FOR ADDITIVE MANUFACTURING OF MATERIALS

(71) Applicant: Siemens Aktiengesellschaft, München (DE)

(72) Inventors: Christoph Ernst Ludwig, München (DE); Utz Wever, Starnberg (DE); Meinhard Paffrath, Feldkirchen (DE); Diana Manvelyan, München (DE)

(21) Appl. No.: 18/714,618

(22) PCT Filed: Nov. 15, 2022
(86) PCT No.: PCT/EP2022/081944

§ 371 Date: May 30, 2024

(30) Foreign Application Priority Data
Dec. 3, 2021 (EP) 21212278.2

(51) Int. Cl. B22F 10/85; B22F 10/28; B22F 12/37; B29C 64/153; B29C 64/245; B29C 64/393; B33Y 10/00; B33Y 30/00; B33Y 50/02

(52) U.S. Cl. CPC B22F 10/85; B22F 10/28; B22F 12/37; B29C 64/153; B29C 64/245; B29C 64/393; B33Y 10/00; B33Y 30/00; B33Y 50/02

(57) ABSTRACT

Disclosed is a “Powder Bed Fusion” technique by sintering or melting through a sinter/melting device executed by a simulation model assigned to a control unit and under a control sovereignty of the control unit powder material, being fillable into a powder material bed, to tilt according to the simulation model and under the control sovereignty of the control unit a build platform of the powder material bed, in which the sintered or melted powder material an additive manufactured object is built up layer by layer on the build platform in a cavity of an additive manufacturing machine and wherein the build platform is both, moveable downwards or upwards and tiltable clockwise or counter-clockwise,: within the cavity during the layer by layer build-up an overhang angle as a maximum allowable additive manufacturing angle either referring to an additive manufacturing level is not undershot or an additive manufacturing direction is not exceeded.

### CROSS-REFERENCE TO RELATED APPLICATIONS

This application claims priority to PCT Application No. PCT/EP2022/081944, having a filing date of Nov. 15, 2022, which claims priority to EP Application No. 21212278.2, having a filing date of Dec. 3, 2021, the entire contents both of which are hereby incorporated by reference.

### FIELD OF TECHNOLOGY

The following relates to a method for additive manufacturing of materials and a machine for additive manufacturing of materials.

### BACKGROUND

Additive manufacturing sometimes also called as or including 3D-or inter alia 4D-printing, is a manufacturing process, which uses materials, such as metals, alloys or polymers, to build up layer by layer structures of an additive manufactured object or the object itself.

According to https://en.wikipedia.org/wiki/3D_printing in the version of Nov. 16, 2021 with reference to a ISO/ASTM52900-15 standardization paper of the International Organization for Standardization <ISO>respectively the American Society for Testing and Materials <ASTM>there are defined seven categories of additive manufacturing processes within its meaning: binder jetting, directed energy deposition, material extrusion, material jetting, powder bed fusion, sheet lamination, and vat photopolymerization.

In the context of embodiments of the present invention Powder Bed Fusion techniques <PBF>including several processes such as Selective Laser Sintering <SLS>, Selective Laser Melting <SLM>and Electron-Beam Melting <EBM>, are considered more closely. Powder Bed Fusion processes can be used with numerous materials, such as metals alloy and polymers, and their flexibility allows a build-up for geometrically complex objects or structures and is based primarily on sintering or melting.

There are certain limitations with respect to a design of the object to be manufactured or a part thereof. One of those limitations is that it is not wanted if not impossible sometimes to additive manufacture or print objects or structures with large angles beyond an overhang angle as those are generally not self-supporting. A definition of the term overhang angle is given in [1] to [2].

General remarks regarding the principle of the Powder Bed Fusion process, in particular the SLM-process, is given and illustrated according to the following YouTube-link https://www.youtube.com/watch?v=te9OaSZ0kf8 (“ New method of manufacturing using powder bed: Additive Manufacturing with Selective Laser Melting”).

From literature it can be assumed that overhang angles up to a critical angle, e.g., often 45°, can be manufactured with a Powder Bed Fusion technique <PBF> (cf. [1]). Larger angles are possible but have a negative effect on the surface properties (cf. [2]). In the past it was suggested to change a scan angle to be able to print larger overhang angles (cf [2]).

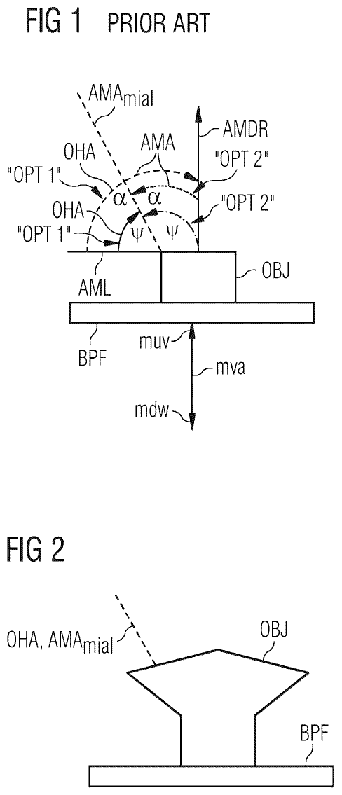

FIG. 1—as state of the conventional art-illustrates this problem. To build up an additive manufactured object OBJ on a build platform BPF by the Powder Bed Fusion technique <PBF>many materials, e.g., the cited ones above, can be used or manufactured additively. In conventional additive manufacturing machines or 3D printers using the PBF-technique the build platform BPF is moveable mva vertically such as downwards mdw or upwards muw in order to apply a new layer of powder in a power bed.

The build-up of the additive manufactured object OBJ however can be only established if (i) according to a first option “OP1” an additive manufacturing angle AMA given by “α” and referring to an additive manufacturing level AML is larger than or equal to a critical overhang angle OHA given by “Ψ”, which means that “α≥Ψ” or in other words the critical overhang angle OHA referring to the additive manufacturing level AML is not undershot or if (ii) according to a second option “OP2” an additive manufacturing angle AMA given by “α” and referring to an additive manufacturing direction AMDR is smaller than or equal to a critical overhang angle OHA given by “Ψ”, which means that “α≥Ψ” or in other words the critical overhang angle OHA referring to the additive manufacturing direction AML is not exceeded. By the “Ψ” for the critical overhang angle OHA it is defined an overhang angle constraint, which is given by a maximum allowable additive manufacturing angle AMAₘₐᵢₗ of the additive manufacturing angle AMA. This angle is represented by a dashed line in the FIG. 1. The illustrated problem implies restriction or limitations for a design of the object to be manufactured additively and for the additive manufacturing process.

From a state of conventional art according to [3] it is known that the additive manufactured materials to manufacture an additive manufactured object or structures thereof are added layer by layer during the additive manufacturing process to support overhang angles below the critical overhang angle “Ψ” (cf. first option “OPT1”). They are removed after the additive manufacturing process in an additional post-processing step. To further mitigate angle restrictions and limit a number of necessary support structures, the orientation of a part of the object to be manufactured additively is typically selected carefully before the additive manufacturing process.

Moreover, limiting constraints are typically taken into consideration during the design of the part. This way it is possible to include those restrictions into the part requirements. This approach may lead to manufacturable parts but may restrict freedom in the design of the object or the part thereof.

According to a granted European Patent EP 2989514 B1 it is described an optimal placement and orientation of a part including simulation of stresses and a part displacement during the additive manufacturing process or printing process. No variation of a PBF-based additive manufacturing angle or a printing bed angle during the additive manufacturing process is considered therein.

From the US 2017/0252806 A1 it is known a system and a method for additive manufacturing of components. So the system includes (i) a powder receptacle, which is designed to receive a powdered material in the form of a starting material for a component to be manufactured, (ii) a construction platform that is mounted within the powder receptacle and is mounted so as to rotate relative to the powder receptacle about a rotational shaft, (iii) a lowering drive, which is designed to incrementally or continuously lower the construction platform within the powder receptacle, and (iv) an energy input apparatus, which is arranged above an opening in the powder receptacle and is designed to carry out locally selective melting or hardening of a powdered material introduced into the powder receptacle on a surface of the material. The construction platform can be tilted by an angle of inclination relative to a rotational shaft of the rotatable mount.

From the US 2008/0138454 A1 it is known a device for manufacturing a three-dimensional object by a layer-wise solidification of a building material at positions in the respective layers that correspond to the object, which comprises (i) a container arranged in the device, (ii) a support device that is vertically movable in the container, (iii) an upper side of which forms a building platform, on which the three-dimensional object is generated layer-wise, (iv) an application device for applying the building material in powder form onto the building platform, (v) a previously solidified layer and (vi) an energy source that provides a beam for solidifying the building material in powder form. Between the building platform and the inside wall of the container there is a gap that is dimensioned such that the support device can be moved inside of the container in a vertical direction. In order to avoid a passing through of building material, the gap is closed by a seal.

From the DE 20 2019 001440 U1 it is known a plant for additive manufacturing of components is a system, in which the components are produced by a generative manufacturing process. The generative manufacturing can be carried out as an additive manufacturing process, as a process for additive manufacturing or as an additive manufacturing. The generative manufacturing process is a process in which by chemical and/or physical processes from informal materials such as liquids, gels/pastes, powders or similar, a component can be produced. The generative manufacturing process can for example a method by using a Selective Laser Melting (SLM) or an Electron Beam Melting (EBM). These two processes can be assigned to temperature processes. In these usually metal powders are used or melted. Furthermore, the generative manufacturing process is a process using laser sintering, in which polymers, ceramics or metals as materials for manufacturing the components can be used. In a powder-bed-based melting process, such as the SLM-procedure or the EBM-procedure, the powder, in particular metal powder, is melted in layers to create the components. The powder is usually in a powder chute. Inside the powder chute, a building platform or table can be moved upwards and downwards during the manufacturing process. A brush seal is used to seal the movable platform or table against the powder chute in the plant for the additive manufacturing of components.

From the US 2021/0107223 it is known an additive manufacturing system with removable module having a build plate on kinematic mounts, wherein the system includes (i) an annular powder bin for powder material, such as a metal or polymer, to surround the build plate, (ii) a support structure to hold the build plate in an interior of the powder bin, and (iii) a kinematic mount assembly for the support structure. The kinematic mount assembly includes at least three independently vertically kinematic mounts that support the support structure, and one or more actuators to independently control vertical motion of the kinematic mounts to control a tilt angle of the support structure and build plate.

### SUMMARY

An aspect relates to a method and machine for additive manufacturing of materials, in which the material can be manufactured additively without any additive manufacturing constraints restricted or limited due to a design of additive manufactured objects.

The main idea of embodiments of the invention in order to additive manufacture powder material based on a “Powder Bed Fusion <PBF>”-technique by way of sintering or melting through a sinter/melting device executed according to a simulation model assigned to a control unit and under a control sovereignty of the control unit the powder material, being fillable into a powder material bed, a build platform of the powder material bed, in which due to the sintered or melted powder material an additive manufactured object is built up layer by layer on the build platform in a cavity of an additive manufacturing machine and wherein the build platform is both, moveable downwards or moveable upwards and tiltable clockwise or tiltable counter-clockwise, is tilted according to the simulation model and under the control sovereignty of the control unit within the cavity such that during the layer by layer build-up an overhang angle as a maximum allowable additive manufacturing angle either referring to an additive manufacturing level is not undershot or referring to an additive manufacturing direction is not exceeded.

Due to the described tilting of the build platform of the powder material bed the necessity of additional supporting structures or postprocessing measures regarding the “Powder Bed Fusion <PBF>”-technique can be avoided. This yields two significant advantages:
Less scrap powder material. The support structure usually cannot be reused and are discarded.
Less postprocessing time. Additional time is needed to remove superfluous support structures. After removal, additional surface treatment might be necessary.

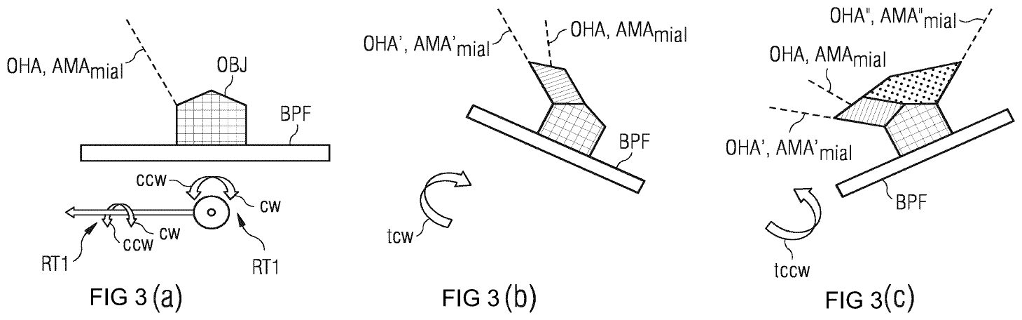

The fundamental technical feature are (i) the tiltable build platform of the powder material bed, which means that the build platform can rotate around one or more axes (cf. FIG. 3), and (ii) the (a priori) simulation model including a digital-twin of the object to be additive manufactured for the additive manufacturing process based on the “Powder Bed Fusion <PBF>”-technique that is able to consider the tilts or rotations of the build platform to build up the object.

Embodiments of the invention uses-with respect to description of the FIG. 1—the fact that the critical overhang angle OHA given by “Ψ′” is always measured with respect to the additive manufacturing direction which, in turn, always points vertically downwards. By tilting or rotating the printing bed and the object to be additive manufactured, the additive manufacturing angle constraint can effectively be alleviated (cf. FIG. 3).

It is beneficial that the build platform includes a deformable sealing to enable a form-fitting in the cavity and to seal the powder material bed during its being moveable downwards or moveable upwards and during the tilting of the build platform for avoiding a leaking of the powder material.

In this context is advantageous when the build platform of the powder material bed and the cavity of the additive manufacturing machine are formed rectangular or circular.

Moreover, it is beneficial when the powder material is a metal or an alloy or when alternatively, the powder material is a polymer.

Besides that it is meaningful or useful when the sintering or melting is done by a Laser or when alternatively the sintering or melting is done by an electron-beam.

### BRIEF DESCRIPTION

Some of the embodiments will be described in detail, with references to the following Figures, wherein like designations denote like members, wherein:

FIG. 1 shows an additive manufactured object:

FIG. 2 shows an additive manufactured object, which in comparison to that of the FIG. 1 has to be additive manufactured further:

FIG. 3(a) shows a fundamental additive manufacturing phases of the additive manufactured object to be additive manufactured in order to achieve a build-up of the additive manufactured object according to the FIG. 2:

FIG. 3(b) shows a fundamental additive manufacturing phases of the additive manufactured object to be additive manufactured in order to achieve a build-up of the additive manufactured object according to the FIG. 2;

FIG. 3(c) fundamental additive manufacturing phases of the additive manufactured object to be additive manufactured in order to achieve a build-up of the additive manufactured object according to the FIG. 2:

4 shows an additive manufacturing process for different process states based each on the “Powder Bed Fusion <PBF>”-technique with an additive manufacturing machine AMM for additive manufacturing materials:

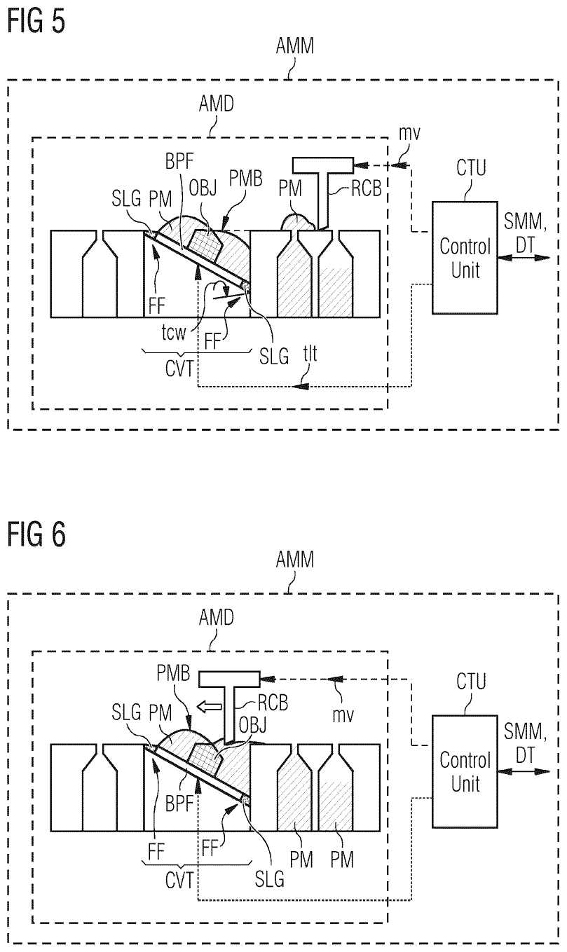

FIG. 5 shows an additive manufacturing process for different process states based each on the “Powder Bed Fusion <PBF>”-technique with an additive manufacturing machine AMM for additive manufacturing materials:

FIG. 6 shows an additive manufacturing process for different process states based each on the “Powder Bed Fusion <PBF>”-technique with an additive manufacturing machine AMM for additive manufacturing materials:

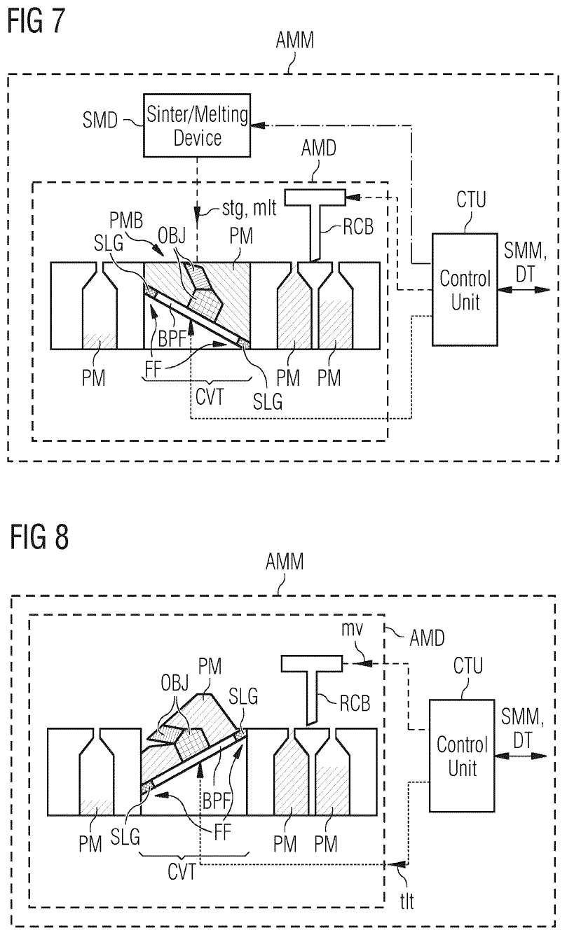

FIG. 7 shows an additive manufacturing process for different process states based each on the “Powder Bed Fusion <PBF>”-technique with an additive manufacturing machine AMM for additive manufacturing materials:

FIG. 8 shows an additive manufacturing process for different process states based each on the “Powder Bed Fusion <PBF>”-technique with an additive manufacturing machine AMM for additive manufacturing materials:

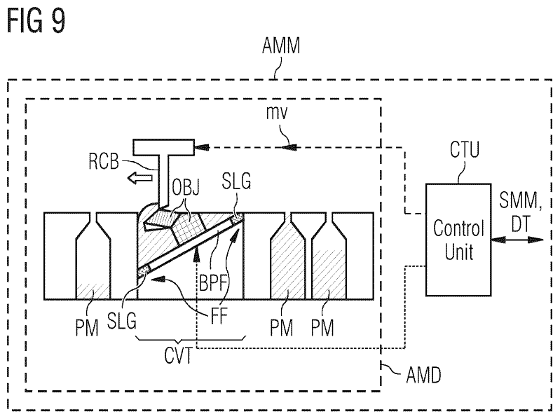

FIG. 9 shows an additive manufacturing process for different process states based each on the “Powder Bed Fusion <PBF>”-technique with an additive manufacturing machine AMM for additive manufacturing materials:

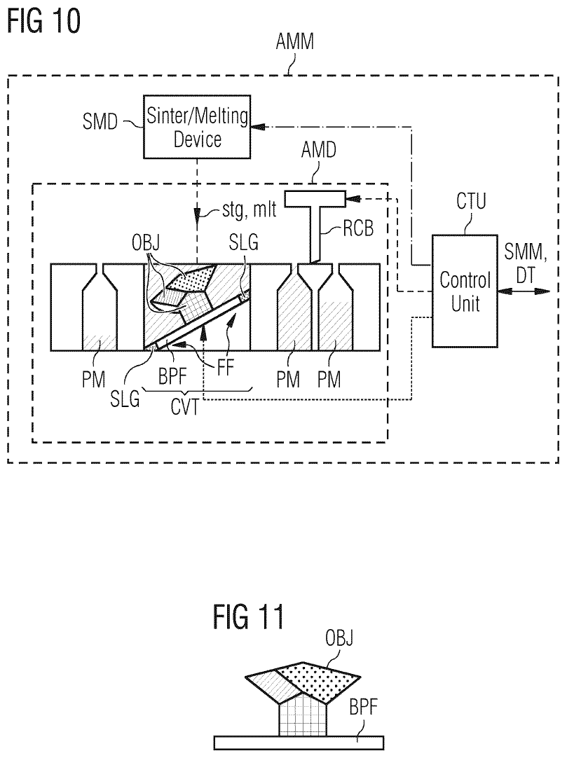

FIG. 10 shows an additive manufacturing process for different process states based each on the “Powder Bed Fusion <PBF>”-technique with an additive manufacturing machine AMM for additive manufacturing materials; and

FIG. 11 shows an additive manufacturing process for different process states based each on the “Powder Bed Fusion <PBF>”-technique with an additive manufacturing machine AMM for additive manufacturing materials:

### DETAILED DESCRIPTION

FIG. 2 shows the additive manufactured object OBJ, which in comparison to that one of the FIG. 1 has to be additive manufactured further. This further additive manufacturing, where the additive manufactured object OBJ finally manufactured is built up on the build platform BPF, violates the critical overhang angle OHA respectively the maximum allowable additive manufacturing angle AMAₘₐᵢₗ of the additive manufacturing angle AMA. If this not the case, the additive manufactured object OBJ, which in comparison to that one of the FIG. 1 has to be additive manufactured further, cannot be manufactured directly without employing additional supporting structures or postprocessing measures regarding the “Powder Bed Fusion <PBF>”-technique.

FIG. 3 shows fundamental additive manufacturing phases (a) to (c) of the additive manufactured object OBJ in order to achieve a build-up of the additive manufactured object OBJ according to the FIG. 2, where the additive manufactured object OBJ finally manufactured is built up on the build platform BPF such that the critical overhang angle OHA respectively the maximum allowable additive manufacturing angle AMAₘₐᵢₗ of the additive manufacturing angle AMA is not violated (non-violating a maximum additive manufacturing angle constraint).

In order to achieve this, the following has to be done:

Firstly, the additive manufactured object OBJ is built up according to a first depicted fundamental additive manufacturing phase (a) for example so far as depicted by a checkered part of the additive manufactured object OBJ. Furthermore, the build platform BPF with the checkered part of the additive manufactured object OBJ can rotate around two axes each clockwise cw or counter-clockwise ccw.

According to a first rotation RT1, when the build platform BPF is rotated clockwise cw, the build platform BPF with the checkered part of the additive manufactured object OBJ is built up on the build platform BPF is tilted into the drawing plane, whereas, when the build platform BPF is rotated counter-clockwise ccw, the build platform BPF with the checkered part of the additive manufactured object OBJ built up on the build platform BPF is tilted out of the drawing plane

According to a second rotation RT2, when the build platform BPF is rotated clockwise cw; the build platform BPF with the checkered part of the additive manufactured object OBJ built up on the build platform BPF is tilted to the right as depicted in (b) of the FIG. 3, whereas, when the build platform BPF is rotated counter-clockwise ccw, the build platform BPF with the checkered part of the additive manufactured object OBJ built up on the build platform BPF is tilted to the left as depicted in (c) of the FIG. 3.

Secondly, the additive manufactured object OBJ is built up further according to a second depicted fundamental additive manufacturing phase (b). In order to build up on the checkered part of the additive manufactured object OBJ a lined part of the additive manufactured object OBJ on the build platform BPF without violating the critical overhang angle OHA respectively the maximum allowable additive manufacturing angle AMAₘₐᵢₗ of the additive manufacturing angle AMA the build platform BPF is rotated clockwise cw according to the second rotation RT2 so that the build platform BPF with the checkered part of the additive manufactured object OBJ built up on the build platform BPF is tilted to the right as depicted in (b) of the FIG. 3.

Due to the fact that the build platform BPF is rotated clockwise cw according to the second rotation RT2 the critical overhang angle OHA respectively the maximum allowable additive manufacturing angle AMAₘₐᵢₗ is no longer critical and according to the cited clockwise rotation a changed (new) overhang angle OHA′ respectively a changed maximum allowable additive manufacturing angle AMA′ₘₐᵢₗ of the additive manufacturing angle AMA becomes the critical one.

While the critical overhang angle OHA respectively the maximum allowable additive manufacturing angle AMAₘₐᵢₗ would have been violated due to the built-up of the lined part of the additive manufactured object OBJ on the build platform BPF the changed (new) overhang angle OHA′ respectively the changed (new) maximum allowable additive manufacturing angle AMA′ₘₐᵢₗ is not violated (non-violating the maximum additive manufacturing angle constraint). So, it is not necessary to employ additional supporting structures or postprocessing measures regarding the “Powder Bed Fusion <PBF>”-technique.

Thirdly, the additive manufactured object OBJ is built up again further according to a second depicted fundamental additive manufacturing phase (c). In order to build up on the checkered part and the lied part of the additive manufactured object OBJ a punctured part of the additive manufactured object OBJ on the build platform BPF without violating the critical overhang angle OHA respectively the maximum allowable additive manufacturing angle AMAmail of the additive manufacturing angle AMA the build platform BPF is rotated now from the rotating position in the FIG. 2 counter-clockwise ccw according to the second rotation RT2 so that the build platform BPF with the checkered part and the lined part of the additive manufactured object OBJ built up on the build platform BPF is tilted to the left as depicted in (c) of the FIG. 3.

Due to the fact that the build platform BPF is rotated now counter-clockwise ccw according to the second rotation RT2 the critical overhang angle OHA respectively the maximum allowable additive manufacturing angle AMAₘₐᵢₗ and the changed (new) overhang angle OHA′ respectively the changed (new) maximum allowable additive manufacturing angle AMA′ₘₐᵢₗ are no longer critical, but according to the cited counter-clockwise rotation an due to the built-up of the punctured part of the of the additive manufactured object OBJ a further changed (further new) overhang angle OHA″ respectively a further changed (further new) maximum allowable additive manufacturing angle AMA′ₘₐᵢₗ of the additive manufacturing angle AMA becomes the critical one, which has to be considered so that the further changed (further new) overhang angle OHA″ respectively the further changed (further new) maximum allowable additive manufacturing angle AMA″ₘₐᵢₗ is not violated (non-violating the maximum additive manufacturing angle constraint). Thus, it is again not necessary to employ additional supporting structures or postprocessing measures regarding the “Powder Bed Fusion <PBF>”-technique.

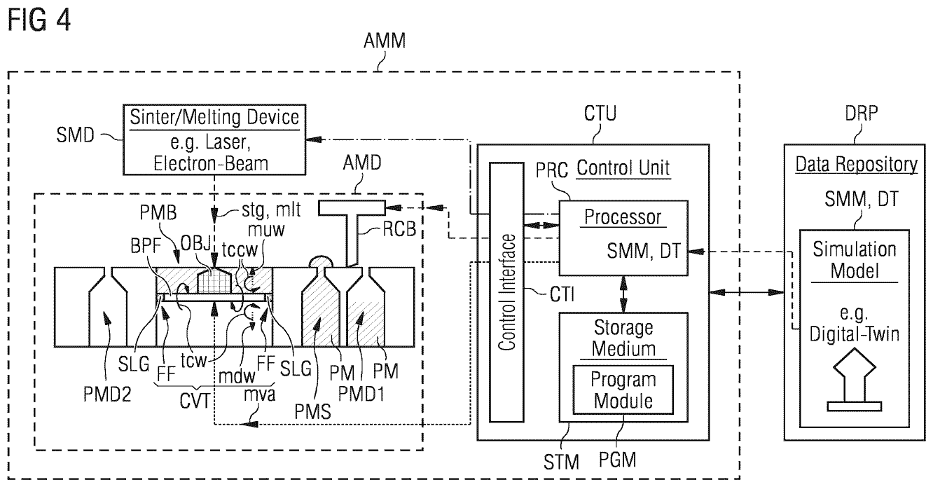

FIGS. 4 to 11 show an additive manufacturing process for different process states based each on the “Powder Bed Fusion <PBF>”-technique-for example a Direct Metal Laser Sintering <DMLS>, which is one of the most frequently used additive Manufacturing processes, where the additive manufactured parts naturally stick to a powder material bed so that this adhesion can be used for bed rotation, such that no additional fixation of the additive manufactured part is necessary-with an additive manufacturing machine AMM for additive manufacturing materials.

According to the FIG. 4, the additive manufacturing machine AMM includes an additive manufacturing device AMM, a sinter/melting device SMD and a control unit CTU.

In order to implement a “Powder Bed Fusion <PBF>”-technique with the additive manufacturing machine AMM the cited machine components form a functional unit for the additive manufacturing. For this purpose, the cited machine components are designed as follows:

1. The additive manufacturing device AMM, which is depicted in the FIGS. 4 to 11 in a cross-sectional view includes
a cavity CVT, in which a powder material bed PMB, where powder material PM can be filled in, is formed due to a cavity interior wall and a build platform BPF, which
is moveable mva downwards mdw or moveable mva upwards muw in the cavity CVT thereby changing a filling volume of the powder material bed PMB,
with respect to the FIG. 3(a) with the corresponding description and according to the described and depicted rotations RTI, RT2 around the two axes is tiltable clockwise tow or tiltable counter-clockwise tccw, and
includes a deformable sealing SLG to enable a form-fitting FF in the cavity CVT and to seal the powder material bed PMB during its being moveable mva downwards mdw or moveable mva upwards muw and during the tilting tlt of the build platform BPF for avoiding a leaking of the powder material PM, wherein the cavity CVT and the build platform BPF are formed rectangular or circular,
a powder material supply PMS keeping the powder material PM,
two powder material disposals-a first powder material disposals PMDI and a second powder material disposals PMD2—for taking superfluous or excessive powder material of the additive manufacturing process as depicted in the FIGS. 4 to 11, and
a recoater blade RCB for filling the powder material PM from the powder material supply PMS keeping the powder material PM in a known way according to the “Powder Bed Fusion <PBF>”-technique.

2. The sinter/melting device SMD is used by way of sintering stg or melting mlt the powder material PM, which is done by a Laser or an electron-beam, in order to build up within the powder material bed PMB layer by layer the additive manufactured object OBJ to be manufactured additively on the build platform BPF.

3. The control unit CTU includes
a non-transitory, processor-readable storage medium STM having processor-readable program-instructions of a program module PGM stored in the non-transitory, processor-readable storage medium STM for carrying out a simulation model SMM including a digital-twin DT of the additive manufactured object OBJ to be manufactured additively, which are stored in a data repository DRP assigned to control unit CTU, and
a processor PRC connected with the storage medium STM executing the processor-readable program-instructions of the program module PGM excercising a control sovereignity of the control unit CTU by accessing to the simulation model SMM with the digital-twin DT stored in the data repository DRP and controlling via a control interface CTI of the control unit CTU the movement and tilting of the build platform BPF within the cavity CVT, the recoater blade RCB and the sinter/melting device SMD for sintering stg or melting mlt the powder material PM.

With respect to the FIG. 4, according to the FIG. 3 (a) and under the control sovereignty of the control unit CTU with the processor PRC the sinter/melting device SMD for sintering stg or melting mlt the powder material PM is controlled according to the simulation model SMM to build up the checkered part of the additive manufactured object OBJ on the build platform BPF.

With respect to the FIG. 5 and under the control sovereignty of the control unit CTU with the processor PRC, when the checkered part of the additive manufactured object OBJ is built up, the build platform BPF is tilted tlt according to the simulation model SMM in the clockwise tcw manner according to the FIG. 3 (b) and the recoater RCB is moved my according to the simulation model SMM to fill the tilted powder material bed PMB with the checkered part of the additive manufactured object OBJ on the tilted build platform BPF with further powder material PM from the powder material supply PMS.

The powder material is distributed by the recoater blade. If the build platform is not rotated respectively tilted, this distribution step is straightforward and state of the conventional art. After the rotation respectively tilt of the tilted powder material bed with the checkered part of the additive manufactured object on the tilted build platform, the geometry changes and hence the requirements on the amount of additional powder material has changed. Those new requirements in added powder material need to be calculated by the simulation model.

With respect to the FIG. 6 and under the control sovereignty of the control unit CTU with the processor PRC, when the tilted powder material bed PMB with the checkered part of the additive manufactured object OBJ on the tilted build platform BPF is filled with the further powder material PM, the recoater RCB is moved my according to the simulation model SMM to remove the superfluous or excessive powder material PM from the tilted powder material bed PMB with the checkered part of the additive manufactured object OBJ on the tilted build platform BPF.

With respect to the FIG. 7, according to the FIG. 3 (b) and under the control sovereignty of the control unit CTU with the processor PRC, when the superfluous or excessive powder material PM from the tilted powder material bed PMB with the checkered part of the additive manufactured object OBJ on the tilted build platform BPF is removed, the sinter/melting device SMD for sintering stg or melting mlt the powder material PM is controlled according to the simulation model SMM to build up the lined part layer by layer on the horizontal surface of the additive manufactured object OBJ on the build platform BPF.

With respect to the FIG. 8 and under the control sovereignty of the control unit CTU with the processor PRC, when the lined part of the additive manufactured object OBJ is built up, the build platform BPF is tilted tlt according to the simulation model SMM in the counter-clockwise tcw manner according to the FIG. 3 (c) and the recoater RCB is moved my according to the simulation model SMM to fill the tilted powder material bed PMB with the checkered and lined parts of the additive manufactured object OBJ on the tilted build platform BPF with further powder material PM from the powder material supply PMS.

The powder material is distributed by the recoater blade. If the build platform is not rotated respectively tilted, this distribution step is straightforward and state of the conventional art. After the rotation respectively tilt of the tilted powder material bed with the checkered and lined parts of the additive manufactured object on the tilted build platform, the geometry changes and hence the requirements on the amount of additional powder material has changed. Those new requirements in added powder material need to be calculated by the simulation model.

With respect to the FIG. 9 and under the control sovereignty of the control unit CTU with the processor PRC, when the tilted powder material bed PMB with the lined part of the additive manufactured object OBJ on the tilted build platform BPF is filled with the further powder material PM, the recoater RCB is moved my according to the simulation model SMM to remove the superfluous or excessive powder material PM from the tilted powder material bed PMB with the checkered and lined parts of the additive manufactured object OBJ on the tilted build platform BPF.

With respect to the FIG. 10, according to the FIG. 3 (c) and under the control sovereignty of the control unit CTU with the processor PRC, when the superfluous or excessive powder material PM from the tilted powder material bed PMB with the checkered part of the additive manufactured object OBJ on the tilted build platform BPF is removed, the sinter/melting device SMD for sintering stg or melting mlt the powder material PM is controlled according to the simulation model SMM to build up the punctured part layer by layer on the horizontal surface of the additive manufactured object OBJ on the build platform BPF.

FIG. 11 shows with regard to the additive manufactured object OBJ to be manufactured additively and depicted in the FIG. 2 the additive manufactured object OBJ built up with the three different parts-the checkered part, the lined part and the punctured part—according to additive manufacturing process based on the “Powder Bed Fusion <PBF>”-technique and depicted in the FIGS. 4 to 10.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

References:
[1] Calignano, F.: Design optimization of supports for overhanging structures in aluminum and titanium alloys by selective laser melting.
[2] Cloots, Michael & Zumofen, Livia & Spierings, Adriaan & Kirchheim, Andreas & Wegener, Konrad. (2017). Approaches to minimize overhang angles of SLM parts. Rapid Prototyping Journal. 23. 362-369. 10.1108/RPJ-05-2015-0061.

[3] Leutenecker. Bastian & Klahn. Christoph & Meboldt. Mirko. (2016). Considering Part Orientation in Design for Additive Manufacturing. Procedia CIRP. 50. 408-413.0.1016/j.procir.2016.05.016.

1. A method for additive manufacturing materials, in which the additive manufacturing is based on a “Powder Bed Fusion”-technique, wherein powder material, which is fillable into a powder material bed of an additive manufacturing machine, is used by way of sintering or melting -through a sinter/melting device to build up within the powder material bed layer by layer an additive manufactured object on a build platform of the powder material bed, which is both, moveable wave downwards or moveable upwards and tiltable clockwise or tiltable counter-clockwise, in a cavity of the additive manufacturing machine thereby changing a filling volume of the powder material bed for the powder material,
executing according to a simulation model which includes a digital-twin of the additive manufactured object and is assigned to a control unit, and under a control sovereignty of the control unit the sintering or melting based build-up through the sinter/melting device, and
tilting according to the simulation model and under the control sovereignty of the control unit the build platform within the cavity such that during the layer by layer build-up an overhang angle as a maximum allowable additive manufacturing angle either referring to an additive manufacturing level is not undershot or referring to an additive manufacturing direction is not exceeded.

2. The method according to claim 1, wherein the build platform includes a deformable sealing to enable a form-fitting in the cavity and to seal the powder material bed during its being moveable downwards or moveable upwards and during the tilting of the build platform for avoiding a leaking of the powder material.

3. The method according claim 1, wherein the build platform of the powder material bed and the cavity of the additive manufacturing machine are formed rectangular or circular.

4. The method according to claim 1, wherein the powder material is a metal or an alloy.

5. The method according to claim 1, wherein the powder material is a polymer.

6. The method according to claim 1, wherein the sintering or melting is done by a Laser.

7. The method according to claim 1. wherein the sintering or melting is done by an electron-beam.

8. A machine for additive manufacturing materials, with a cavity and a powder material supply of an additive manufacturing device, a sinter/melting device and a control unit, which form a functional unit for the additive manufacturing which is configured such that under a control sovereignty of the control unit and based on a “Powder Bed Fusion technique
powder material is fillable into a powder material bed,
the powder material is used by way of sintering or melting through the sinter/melting device to build up within the powder material bed layer by layer an additive manufactured object on the build platform, which is both, moveable downwards tweew or moveable upwards and tiltable clockwise or tiltable counter-clockwise How, in the cavity, thereby changing a filling volume of the powder material bed (PMB) for the powder material,
a simulation model including a digital-twin of the additive manufactured object and assigned to the control unit to execute under the control sovereignty of the control unit the sintering or melting based build-up through the sinter/melting device. and
tilting under the control sovereignty of the control unit and according to the simulation model the build platform within the cavity such that during the layer by layer build-up an overhang angle as a maximum allowable additive manufacturing angle either referring to an additive manufacturing level is not undershot or referring to an additive manufacturing direction is not exceeded.

9. The machine according to claim 8, wherein the build platform includes a deformable sealing to enable a form-fitting in the cavity and to seal the powder material bed during its being moveable downwards for moveable upwards and during the tilting of the build platform for avoiding a leaking of the powder material.

10. The machine according to claim 8, wherein the build platform of the powder material bed and the cavity of the additive manufacturing machine are formed rectangular or circular.

11. The machine according to claim 8, wherein the powder material is a metal or an alloy.

12. The machine according to claim 8, wherein the powder material is a polymer.

13. The machine according to claim 8, wherein the sinter/melting device is configured such that the sintering or melting is done by a laser.

14. The machine according to claim 8, wherein the sinter/melting device is configured such that the sintering or melting is done by an electron-beam.
